(19) United States
(12) Patent Application Publication
(10) Pub. No.: US 2004/0149339 A1
(43) Pub. Date: Aug. 5, 2004

(54) Micro pump device with liquid tank

(76) Inventor: Neng-Chao Chang, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/358,244

(22) Filed: Feb. 5, 2003

(51) Int. Cl. F16K 37/00

(52) U.S. Cl. 137/559

(57) ABSTRACT

A micro pump device with liquid tank comprises a liquid tank being made of transparent material; and a micro pump having an inlet positioned in centre of the liquid tank and the micro pump locating the side of said liquid tank. And, the liquid tank further includes a first inlet, a second inlet and a vent hole. The pump device provides a cooling system for micro electric device and a liquid tank could provide a closed tank of cooling system.

### BACKGROUND OF THE INVENTION

1. Field of the Invention

The present invention relates to a micro device and more particularly relates to a micro pump with liquid tank which provides a cooling system for micro electric device and a liquid tank could provide a closed tank of cooling system.

2. Description of Related Art

The performance of integrated circuit increases and its size gets smaller. The more heat will be generated by high performance IC and is hard to remove. The heat could be a factor to decide the life of IC. And, the more important device of IC is centre processing unit and conventional removal heat device is no effective removal heat in high speed CPU. Referring to FIG. 1, the conventional cooling system comprises a pump 20 connected to a liquid tank 30. The liquid is pumped form liquid tank 30 by an outlet 205 of pump 20 and was leaded to a cooling system by a pipeline 201. Further, the liquid of cooling system removed the heat of CPU and returned to the liquid tank 30 by a pipeline 203. Therefore, the device has many disadvantages, for example: larger liquid tank, more space for liquid tank and hard moveable of tank. Further more, the top of liquid tank has a opening which could make decrease of liquid. The CPU is damage when the height of liquid in the liquid tank is lower than the outlet 205.

### SUMMARY OF THE INVENTION

It is an object of the present invention is to provide a micro pump device with liquid tank which has a micro pump with a liquid tank for micro electron device, for example: CPU, and could not be offered liquid by other device.

It is another object of the present invention is to provide a micro pump device with liquid tank which has a liquid tank of adding liquid style to maintain the height of liquid in liquid tank and an adding liquid inlet of tank could be sealed to be a closed tank.

It is further object of the present invention is to provide a micro pump device with liquid tank which the micro pump is closely connected to the liquid tank and the inlet pipeline of pump is disposed in horizontal centre of liquid tank. The micro pump device with liquid tank could dispose any direction position (such as vertical position, horizontal position or reverse position) and could not lead the air into the liquid tank.

### BRIEF DESCRIPTION OF THE DRAWINGS

The above and further objects, features and advantages of the invention will become clear from the following more detailed description when read with reference to the accompanying drawings in which:

FIG. 1 is an illustrated view of the cooling system of prior art;

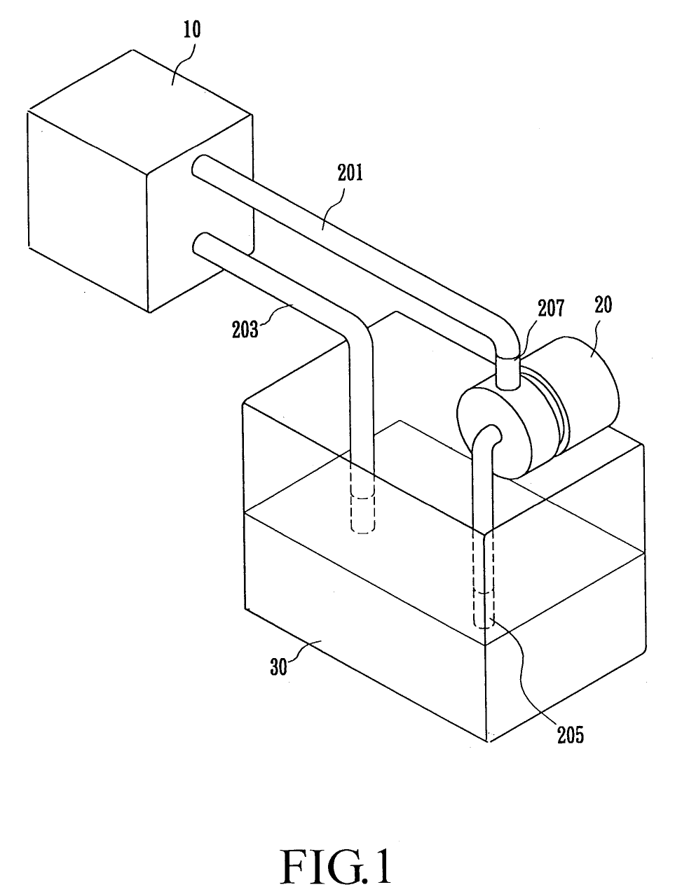

FIG. 2 is a perspective view of the present invention;

FIG. 3 is a sectional view of the present invention; and

FIG. 4 is an illustrated view of the cooling system of the present invention.

### DETAILED DESCRIPTION OF THE PREFERRED EMBODIMENTS

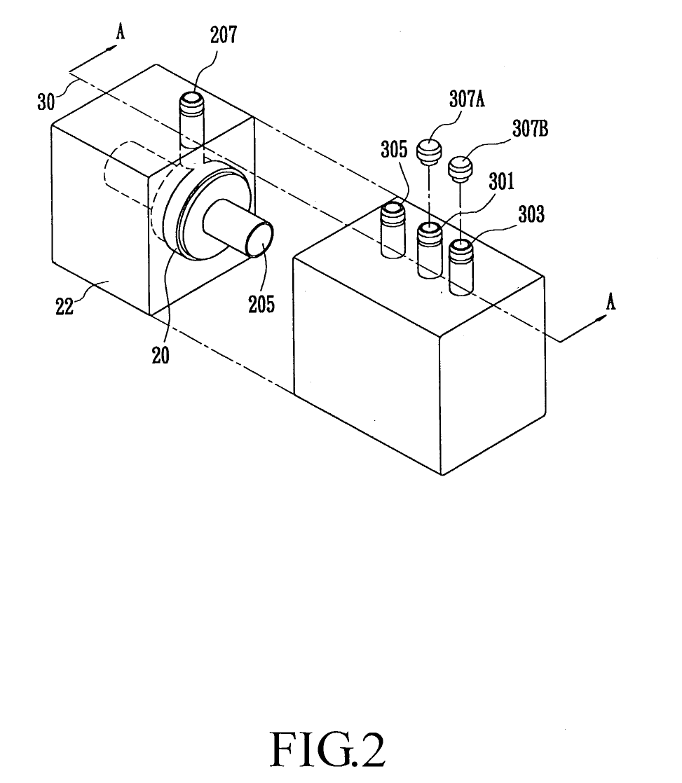

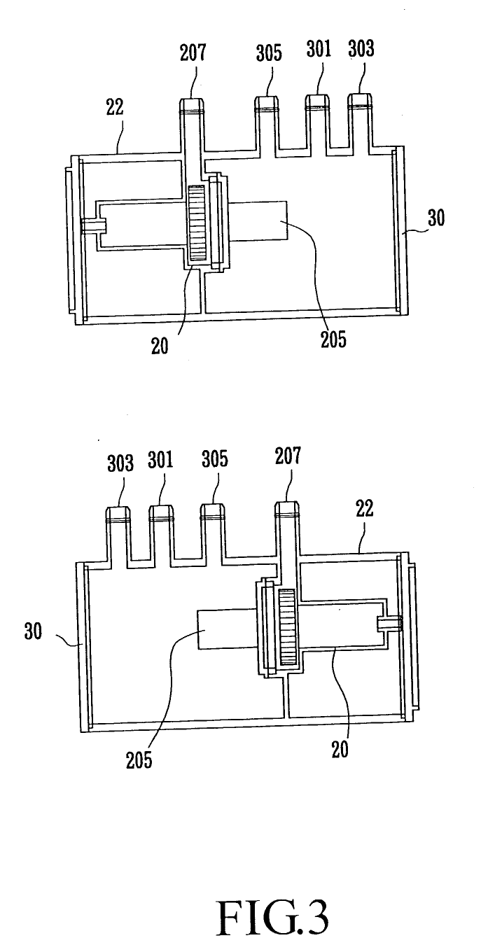

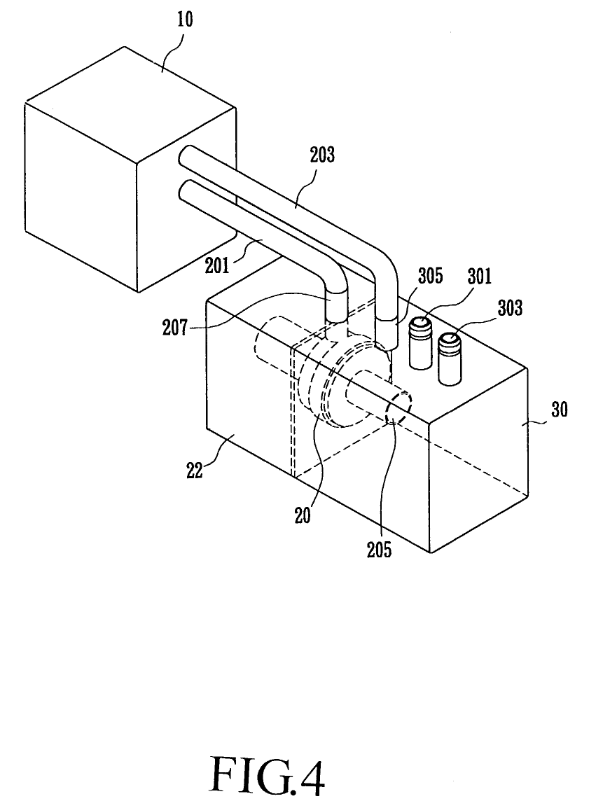

Referring to FIGS. 2 and 3, the present invention discloses a micro pump 20 and a liquid tank 30. The micro pump 20 is covered by a shell 22 and has an inlet 205 which protrudes side of shell 22 and extends to centre of the water tank. The micro pump 20 has an outlet 207 which protrudes the top of shell 22 and is coupled to a cooling system 10 by a pipeline 201. The water tank 30 is disposed side of pump 20 and is covered by the shell 22. Further, the top of water tank 30 includes a first inlet 305, a second inlet 301 and a vent hole 303 for recycling, adding water and emitting. In additional, the second inlet 301 has a first rubber plug 307A and the vent hole 303 has a second rubber plug 307B for preventing the liquid leaked. The first inlet 305 is coupled to the cooling system 10 to be a closed recycling system by pipeline 203 (refer to FIG. 4).

First, removing the rubber plugs 307A and 307B, the liquid tank is filled with liquid by the second inlet 301 and plugs up the second inlet 301 and the vent hole 305 by rubber plugs 307A and 307B. Starting the micro pump 20, the liquid is guided form water tank 30 through the inlet 205 to the outlet 207. And, the water is guided form outlet 207 to the cooling system 10 by pipeline 201 and absorbs the heat. After absorbing heat, the water is flowed to the second inlet 305 of liquid tank 30 by pipeline 203 and flows into the water tank 30. After the liquid being recycled, the plugs 307A and 307B removes form the liquid tank 30 and the liquid tank 30 is refilled with liquid and is plugged by plugs 307A and 307B to be a closed.

The liquid of the liquid tank 30 is decreased by attaching many air bubbles on inside wall of pipelines 201 and 203, inside of cooling system 10 or the inside wall of micro pump 20. Therefore, the present invention discloses the second inlet 301 and vent hole 303 for adding the liquid and emitting air.

The present invention has a major advantage which has the inlet 205 of micro pump 20 disposed in centre of liquid tank 30 and is a closed system. Further more, the pump with liquid tank is a closed system and the pump can not damage by removing the all device to generate the air.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A micro pump device with liquid tank comprising:
a liquid tank being made of transparent material; and
a micro pump having an inlet positioned in centre of said liquid tank and said micro pump locating the side of said liquid tank.

2. The micro pump device as claimed as claim 1, wherein said liquid tank further includes a first inlet, a second inlet and a vent hole.
